(19) United States
(12) Patent Application Publication
(10) Pub. No.: US 2015/0351325 A1
(43) Pub. Date: Dec. 10, 2015

(54) LED GROW LIGHT WITH AUTOMATIC HEIGHT ADJUSTMENT

(71) Applicant: GREENHOUSE HVAC LLC, JACKSONVILLE, FL (US)

(72) Inventors: F. Mack Shelor, Palm Coast, FL (US); Michael McGehee, Atlanta, GA (US); John Adinolfi, Atlanta, GA (US)

(73) Assignee: GREENHOUSE HVAC LLC, JACKSONVILLE, FL (US)

(21) Appl. No.: 14/298,884

(22) Filed: Jun. 7, 2014

(51) Int. Cl. A01G 7/04; H05B 33/08

(52) U.S. Cl. CPC A01G 7/045; H05B 33/0854

(57) ABSTRACT

An efficient scalable networkable grow light system ensures that a DLI suitable for optimal plant growth without causing heat stress is met by selectively illuminating lighting elements of determined wavelengths, and adjusting intensity of the lighting elements, and adjusting the height of an assembly containing the lighting elements, if sensed ambient light is inadequate to meet the DLI. A hoist adjusts height to provide full illumination without causing heat stress, while reducing inefficiency due to excessive distance. If sensed ambient lighting is sufficient to meet the DLI, supplemental lighting is not activated.

### FIELD OF THE INVENTION

This invention relates generally to horticulture, and, more particularly, to a multichannel LED grow light with automatic height adjustment to achieve a determined daily light integral (DLI).

### BACKGROUND

Using electric lighting, such as HID or LED lamps, to supplement natural sunlight during periods of inclement weather or short days allows growers to increase productivity and plant quality by intensifying photosynthesis. Photosynthesis converts energy from the sun, plus carbon dioxide (CO₂) and water (H₂O) into carbohydrates (such as glucose, C₆H₁₂O₆) used for plant growth and oxygen (O₂). Photosynthesis takes place in the chloroplasts, specifically using pigments such chlorophyll and carotenoids. Photons that have a wavelength between 400 and 700 nanometers (nm) provide the energy for photosynthesis. More specifically, light is mostly absorbed by chlorophyll in the blue (400 nm-500 nm) and red (600 nm-700 nm) regions (i.e. wavelengths) of the light spectrum and by carotenoids in the blue region.

Daily light integral (DLI) refers to the number of photosynthetic light particles, or photons, received during one day in a particular location and area. The DLI specifically refers to the amount of light received in 1 m² per day. It is measured in mol·m⁻²·d⁻¹, i.e., moles of light (mol) photons per square meter (m⁻²) per day (d⁻¹), with each mol consisting of 6.02×10²³ photons of light.

The maximum DLI is about 60 mol·m⁻²·d⁻¹ and occurs outdoors on a cloudless day in the summer when the photoperiod is long. The DLI outdoors may be less than 5 mol·m⁻²·d⁻¹ in the winter on a dark, cloudy, short day in the northern part of the United States or Canada. Inside a greenhouse, the structure and glazing materials commonly reduce light transmission by 35-50 percent. In a greenhouse, values seldom exceed 25 mol·m⁻²·d⁻¹ because of greenhouse glazing materials and superstructure, the season (which affects the sun's angle), cloud cover, day length (photoperiod), shading, and greenhouse obstructions, such as hanging baskets. Therefore, the DLI inside a greenhouse in the United States may be from about 5 to 30 mol·m⁻²·d⁻¹, depending upon location, season and greenhouse configuration.

The DLI that is needed to grow high-quality plants depends upon the crop, but a common target minimum DLI inside a greenhouse is 10-12 mol·m⁻²·d⁻¹. Plant quality generally increases as the average DLI increases. In particular, as the DLI increases, branching, rooting, stem thickness and flower number increase.

When the DLI is low outdoors, growers are wise to maximize the amount of natural light that can reach their crops. For example, shading may be removed, glazing may be cleaned and overhead obstructions may be kept to a minimum. If such measures are impractical or insufficient, the DLI may be increased by supplemental lighting.

While beneficial, supplemental lighting is not without risks. Supplemental lighting outside the blue and red wavelengths may limit productivity. Excessive supplemental lighting may harm plants. Heat from excessive lighting can be detrimental. Photosynthesis and other plant growth processes shut down when the environmental and tissue temperature gets high enough from heat energy that comes with the light. At that point all the water taken up by the plant is used to cool the plant tissue. Plants receiving excessive amounts of light thus dry up, become bleached through the destruction of chlorophyll, and may display other symptoms of excessive stress. At full intensity, supplemental lighting may subject plants to lighting that exceeds the plants' photosynthetic capacity. This may lead to reversible and, eventually, irreversible photoinhibition. While reversible photoinhibition is a temporary protective mechanism, irreversible photoinhibition permanently damages the light-harvesting reactions of the photosynthetic apparatus caused by excess light energy trapped by chloroplasts.

Another complication is distance between the light source and plant. Most supplemental lighting is installed at a fixed height, substantially above the plants. While the fixed height provides clearance for working and growth and allows wide area light coverage, under the inverse square law the decrease in light reaching a surface is proportional to the square of the distance between the light source and the surface. Put simply, light intensity and DLI decrease very rapidly as the distance from the light source increases. Thus, a more powerful light is needed at a greater distance from the plant to deliver light a desired DLI. Conversely, a less powerful light and less energy is needed to deliver the DLI at less distance.

Yet another complication is the wavelengths of light used in supplemental lighting. A range of bulb types can be used as grow lights, such as incandescent, fluorescent, metal halide, high pressure sodium, and LEDs, among others. Incandescent, fluorescent, metal halide, and high pressure sodium lights consume considerable energy to produce light of various wavelengths, some of which are not particularly beneficial to plants. In contrast, LED grow lights typically include only red and blue LEDs, the theory being that light in these wavelengths stimulates photosynthesis. However, this approach ignores other wavelengths in natural sunlight that are also beneficial to plant production.

What is needed is an efficient scalable grow light system, that ensures a DLI suitable for optimal plant growth without causing heat stress. The invention is directed to overcoming one or more of the problems and solving one or more of the needs as set forth above.

### SUMMARY OF THE INVENTION

To solve one or more of the problems set forth above, in an exemplary implementation of the invention, a supplemental LED grow light system for a greenhouse includes an LED light fixture, series of LEDs of separately controlled colored LED lights in the light fixture, a controllable motorized hoist supporting the LED light fixture above plants at an adjustable height, a sensor that detects the intensity or quanta of PAR light reaching the plants, and a control system. An efficient scalable networkable grow light system is provided, The system ensures that a DLI suitable for optimal plant growth without causing heat stress is met by selectively illuminating lighting elements of determined wavelengths, and adjusting intensity of the lighting elements, and adjusting the height of an assembly containing the lighting elements. The system includes a hoist that controls height of the assembly in response to control signals. The height provides full illumination of the covered plants, without causing heat stress, while reducing inefficiency due to excessive distance. A sensor monitors light at plant level throughout a day. If ambient lighting is sufficient, supplemental lighting can be avoided. If ambient lighting is insufficient, supplemental lighting is provided by the system to the extent necessary. If sensed lighting exceeds a saturation point, the supplemental lights may be dimmed.

An exemplary method of automatically illuminating a plurality of plants with an overhead supplemental lighting assembly to facilitate plant growth entails sensing at about a height of and adjacent to the plurality of plants the intensity of light received. A target light intensity is determined for the plurality of plants. The sensed intensity of light is compared with the target light intensity. If the sensed intensity of light is less than the target light intensity, the supplemental lighting assembly is lowered from a raised position to a lowered position and activated to emit supplemental lighting to the plurality of plants. An optical sensor is positioned at about a height of the foliage of and adjacent to the plants. The sensor is an optical sensor such as a photodiode or a quantum PAR sensor sensing photosynthetically active radiation as photosynthetic photon flux density. The target light intensity is a target photosynthetic photon flux density for the certain species of plants, which may be inputted or determined by a computer, such as from a lookup table. To lower the supplemental lighting assembly, a motor is activated. The motor is operably coupled to a spool with a tether partially wound on the spool. The supplemental lighting assembly is directly or indirectly coupled to a free end of the tether. Various mechanical coupling elements may be disposed between the free end and the lighting assembly. The activated motor causes the spool to rotate and tether to unwind from the spool thereby lowering the supplemental lighting assembly. The lowered position is a height above the plants that is far enough from the plants to avoid causing heat stress and illuminate all of the corresponding plants, while being close enough to minimize losses due to distance between the supplemental lighting assembly and the plurality of plants.

A light saturation point for the plants is determined by input or from a lookup table. If the sensed intensity of the light exceeds the saturation point, and the supplemental lighting assembly is in the lowered position and activated, then the supplemental lighting from the supplemental lighting assembly is dimmed. Dimming may be accomplished by pulse width modulation or current regulation.

In one embodiment the supplemental lighting assembly includes red, amber, green, and blue light emitting diodes. In a particular preferred embodiment the lights are 40% red, 20% amber, 20% green, and 20% blue light emitting diodes.

In addition to the methods, an overhead supplemental lighting system for a greenhouse is described. The light assembly includes a housing containing at least one electrically activated lamp emitting photosynthetically active radiation when the light assembly is activated. A hoist includes a plurality of tethers. Each tether is partially wound on a spool and coupled at a free end to the housing. A motor rotates each spool. The light assembly is lowered by the hoist to a lowered position when each spool is rotated in a lowering direction and tethers are unwound from each spool. The light assembly is raised from the lowered position when each spool is rotated in a raising direction and tethers are wound onto each spool. A controller (e.g., PLC) is operably coupled to and controls the motor. By way of example and not limitation, the controller may control a relay coupled to the motor. The PLC causes the hoist to controllably raise and lower and activate and deactivate the light assembly.

An optical sensor is positioned below the light assembly at a height of about the height of plant foliage. The optical sensor produces output signals corresponding to sensed light intensity. The controller determines if a determined a target light intensity exceeds the sensed light intensity, and, if the determined a target light intensity exceeds the sensed light intensity, then activates the light assembly and causes the hoist to lower the light assembly to the lowered position. The optical sensor may be a quantum PAR sensor sensing photosynthetically active radiation as photosynthetic photon flux density. The target light intensity includes a target photosynthetic photon flux density for the certain species of plants. The controller dims the activated lighting assembly in the lowered position if the sensed light intensity exceeds a determined saturation point.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a front view of an exemplary grow light with height adjustment according to principles of the invention; and

FIG. 2 is a perspective view of an exemplary grow light with height adjustment according to principles of the invention; and

FIG. 3 is a plan view of an exemplary servo motor and gear box for a hoist for a grow light with height adjustment according to principles of the invention; and

FIG. 4 is a perspective view of an exemplary servo motor and gear box for a hoist for a grow light with height adjustment according to principles of the invention; and

FIG. 5 is a perspective view of an exemplary programmable logic controller with computer network connectivity for a grow light with height adjustment according to principles of the invention; and

FIG. 6 is a high level network schematic conceptually illustrating a plurality of programmable logic controllers for operably coupled to a plurality of grow lights with height adjustment and capable of being configured and monitored via computer according to principles of the invention; and

FIG. 7 is a high level schematic of a grow light assembly comprising a plurality of independent series of LEDs and corresponding controllable drivers according to principles of the invention; and

FIG. 8 is a high level flow chart illustrating steps of a process of determining cumulative photosynthetic photon flux density (PPFD) over a day in determined time increments according to principles of the invention; and

FIG. 9 is a high level flow chart illustrating steps of a process of activating and lowering a supplemental lighting fixture if the cumulative daily PPFD does not meet a target target value; and

FIG. 10 is a high level flow chart illustrating steps of a process of determining a distance for lowering a supplemental lighting fixture according to principles of the invention; and

FIG. 11 is a high level flow chart illustrating steps of a process of dimming a supplemental lighting fixture according to principles of the invention; and

FIG. 12 conceptually illustrates an exemplary sprocket and chain drive for a hoist of a grow light with height adjustment according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

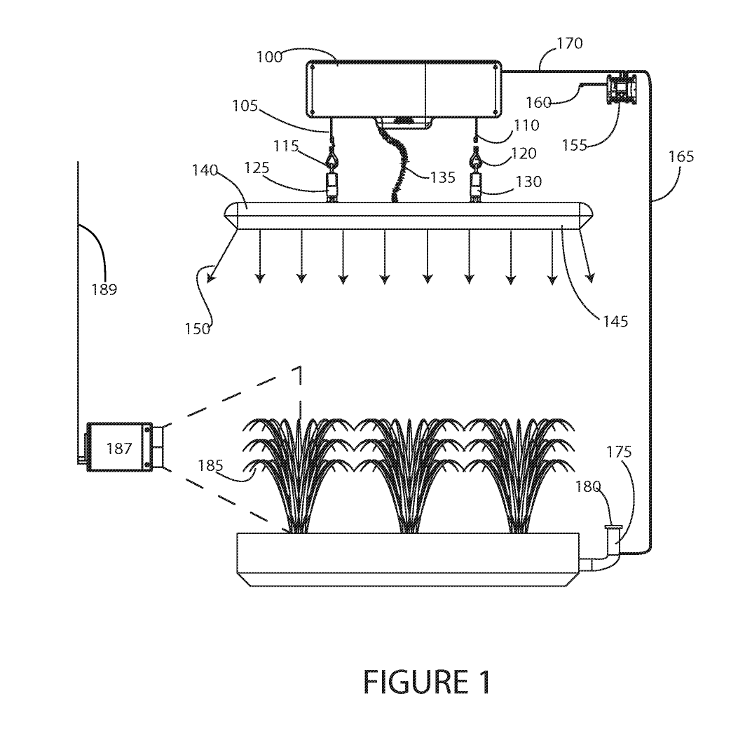

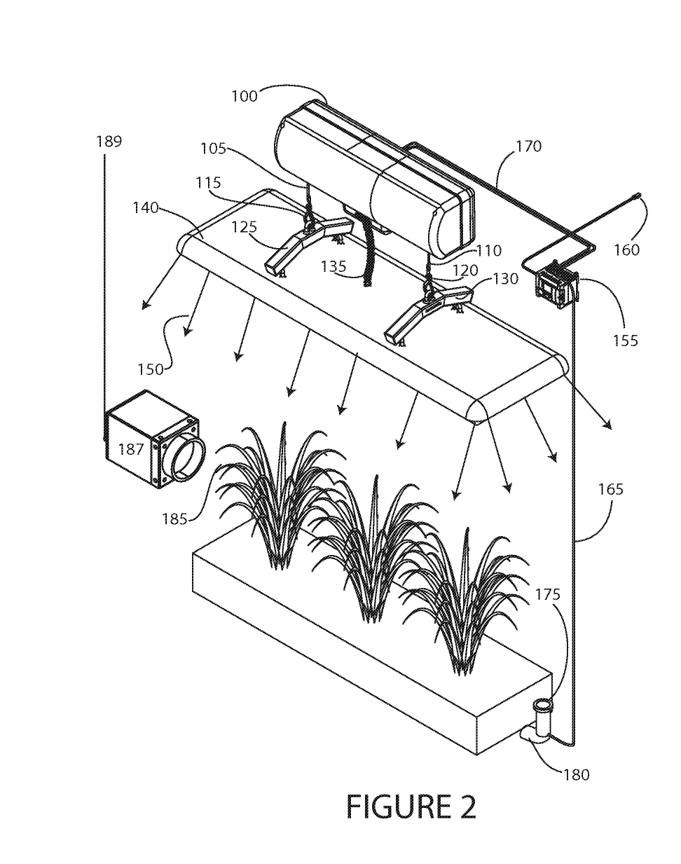

With reference to FIGS. 1 and 2, views of an exemplary grow light system according to principles of the invention is conceptually illustrated. The system includes a hoist 100 having a plurality of tethers 105, 110 (e.g., cables, such as wire rope, or nylon or polyester webbing) that are wound and unwound on spools or drums. The hoist controllably raises or lowers a load, in this case a light assembly 140. The hoist may be configured to raise and lower a support structure such as a pipe to which a plurality of light assemblies are attached.

As discussed below, the hoist 100 contains a controllable electric motor (e.g., a servomotor) and a gear box to simultaneously rotate two spaced apart spools. The servomotor is a rotary actuator that allows for precise control of angular position, velocity and acceleration. It includes a suitable motor coupled to a sensor for position feedback and may also include a braking device, as discussed below.

Each tether 105, 110 is coupled to a yoke 125, 130 using releasable attachments 115, 120 such as carabiners. Each yoke 125, 130 is attached to the light assembly 140. Thus, the light assembly 140 is suspended from the tethers 105, 110. When the tethers 105, 110 are unwound by the hoist 100 the light assembly is lowered. When the tethers 105, 110 are wound by the hoist 100 the light assembly is raised.

The light assembly 140 includes a diverging lens 145. The lens 145 transmits and diverges collimated beams of light 150 emitted from lighting elements within the light assembly 140. By way of example and not limitation, the lens 145 may comprise a biconcave or plano-concave lens, through which collimated beams of light 150 diverge (i.e., spread). In this manner, the light assembly 140 may illuminate an area that is greater than the area of light assembly 140.

In one embodiment, each LED of the light assembly 140 may have a lens with a 120 degree cone from the LED. That would provide a 120 degree cone of light from each LED, or a 60 degree spread of light from vertical under each LED. Such a lens selection may provide light overlap.

One or more plants 185 are positioned beneath the light assembly 140. The plants 185 may be in planters or in soil or other media on the ground below the light assembly 140. The plants 185 occupy an area that can be illuminated by the light assembly 140 when the light assembly 140 is positioned at a particular height or higher. That height, which is the minimum illumination height (hᵢ), depends upon the angle of divergence of the light and the shape and size of the light assembly. Below the minimum illumination height, the diverging light beams may not reach some of the plants, particularly the peripheral plants. Above the minimum illumination height, the diverging light beams may reach substantially beyond the periphery of plants, illuminating areas that do not benefit from the light. Concomitantly, the higher above the minimum illumination height, the more attenuated the light. Under the inverse square law the decrease in light reaching a surface is proportional to the square of the distance between the light assembly 140 and the surface. Light intensity and DLI decrease very rapidly as the distance between the plants 185 and the light assembly 140 increases. Thus, efficient and effective lighting dictates that the light assembly 140 be positioned at or near the minimum illumination height.

The minimum illumination height and area covered by the plants will change as the plants 185 grow. Plant growth may be tracked or estimated. Tracking may be achieved by measurements by personnel or by input from sensors. Such sensors may, by way of example and not limitation, comprise light beam sensors configured to detect a beam of light. When a plant grows to a point that blocks the beam, then the plant height or spread equals or exceeds the beam height. Positioning such sensors at various heights and around the periphery of the plant area enables tracking of plant growth. Alternatively, data regarding plant growth may be input by a user or estimated in advance and stored in an accessible storage medium. For example, the stored data may correlate height and area to age of the particular plants. A system according to principles of the invention may thus determine plant height and area from the stored data.

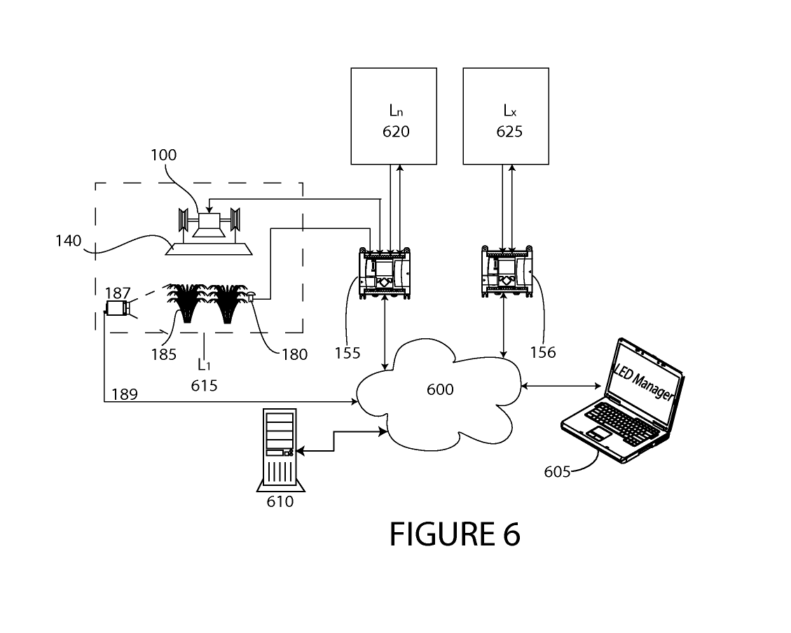

Optionally, in one embodiment, the height of plants is automatically estimated using a sensor. By way of example and not limitation, a camera 187 captures video images of the plants. The camera communicates the captured video image as an analog video signal or a digital video stream to a remote computer system, via a communication line 189, for processing. The computer system (e.g. 610 in FIG. 6) may include a frame grabber that captures individual, digital still frames from the analog video signal or a digital video stream. In one embodiment, the computer system 610 overlays a calibrated grid on a captured frame. Each horizontal line on the calibrated grid corresponds to a height. The computer system may determine the presence of a plant at a particular height by pixel color or other optical discrimination methodology.

In a commercial greenhouse with many bays of plants, each having many plant stations with plants at or about the same stage of growth, one sensor 175 and one camera 187 may be provided for one or more, but not necessarily all, of the stations. In this manner, adjacent stations may rely upon camera and sensor readings from a nearby station. Thus, a plurality of stations may rely upon camera and sensor readings from a single camera and a single sensor. This implementation reduces complexity and cost.

In one embodiment of the invention, estimated plant area for the fully grown plants may be illuminated throughout the growth cycle of the plants. In another embodiment the plant area may be determined periodically, as described above. Concomitantly, the height of the grown plants may be used throughout the plant growth cycle. Alternatively, the height of the plants may be determined periodically during the plant growth cycle.

At least one electric cable 135, such as an extendible self-retracting coiled cable, connects the light assembly 100 to a power supply. The cable 135 is sufficiently long to allow Each cable 135 may contain one or more pairs of insulated wires, abutting, in a jacket, to form a single cable assembly. Each pair of insulated wires may power one or more series of LED lamps in the light assembly 140.

A programmable logic controller (PLC) 155 automates electromechanical processes of the system, including reading sensor output, activating the light assembly to emit light, controlling which, if any, of the channel(s) of LED(s) is(are) illuminated, and controlling the hoist to raise and lower the light assembly 140 in a controlled manner. The PLC 155 is configured for severe conditions (such as dust, moisture, heat, cold) and has a plurality of input/output (I/O) ports. One PLC 155 may serve one or more (e.g., a few) lighting systems depending upon configuration and modularity. The I/O ports connect the PLC 155 to external devices such as sensors, relays, drivers and motors. For example, in FIGS. 1 and 2, I/O ports are connected to the hoist 100 via lines 170, and to the optical sensor 180 via line 165. The PLC 155 executes a PLC program repeatedly as long as the controlled system is running. Input readings are copied to an I/O image table, which is an area of memory accessible to the processor. The PLC program runs from its first instruction rung down to the last rung. In the exemplary embodiment, the PLC 155 has one or more built in communications ports, e.g., RS-232, USB, Ethernet or some other communications port. In such embodiment, the PLC can communicate over a network to one or more computers running a SCADA (Supervisory Control And Data Acquisition) system or web browser. In the exemplary embodiment, an Ethernet connection via Category 5 or 6 cable 160 is illustrated. Additionally, a plurality of PLCs, dozens, hundreds or more, may be networked and controlled from the supervising computer.

An optical sensor 180 is positioned near the plants 185. The sensor is supported by a support structure 175. The support structure may be an adjustable height (e.g., telescopic) support structure to position the sensor at a height approximately equal to the plant height, or at a height between the fully grown height and starting height, or at some other height. The adjustment may be manual or automatic. The sensor 180 is operably coupled to an I/O port of the PLC 155 via line 165.

While various optical sensors may be utilized, in a preferred embodiment the sensor 180 comprises a quantum PAR sensor to measure light available for photosynthesis. Photosynthetically Active Radiation (PAR) may be measured as Photosynthetic Photon Flux Density (PPFD), which has units of quanta (photons) per unit time per unit surface area, e.g., micromoles of quanta per second per square meter (μmol s⁻¹ m⁻²). A quantum PAR sensor typically comprises a silicon photodiode with colored glass filters to tailor the silicon photodiode response to a desired quantum response, and an interference filter that excludes sensed wavelengths above 700 nm and/or below 400 nm, thus excluding non-PAR wavelengths. However, the invention is not limited to use of a quantum PAR sensor. Other optical sensors capable of sensing light and more particularly light intensity, such as photodiodes, photodetectors, photomultiplier tubes and LEDs which are reverse-biased to act as photodiodes, may be utilized in lieu of, or in addition to a quantum PAR sensor. Additionally, while one sensor 180 is shown, a plurality of optical sensors may be utilized to monitor the light incident on the plants. Sensor 180 output is communicated to the PLC 155 via line 165.

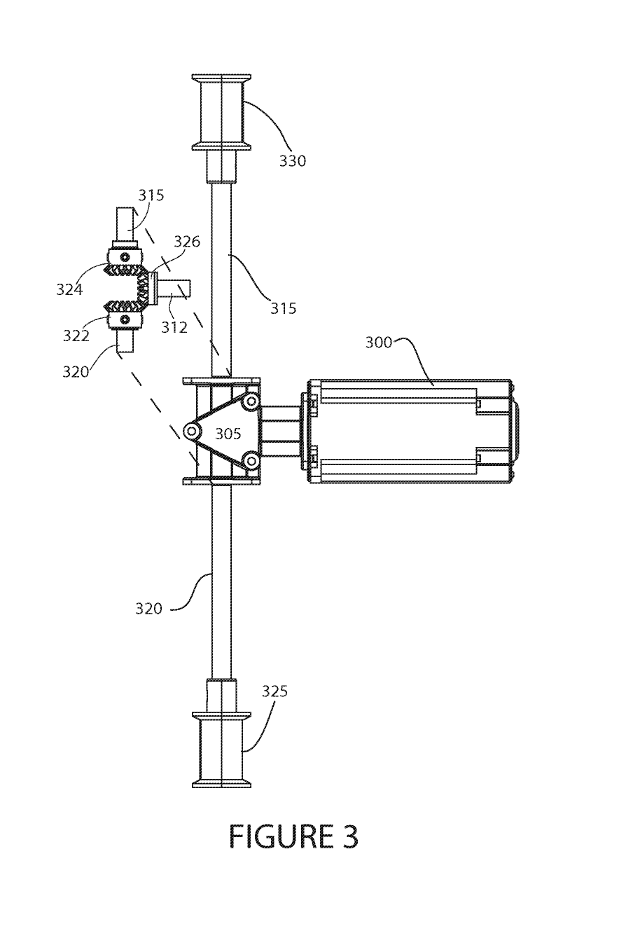

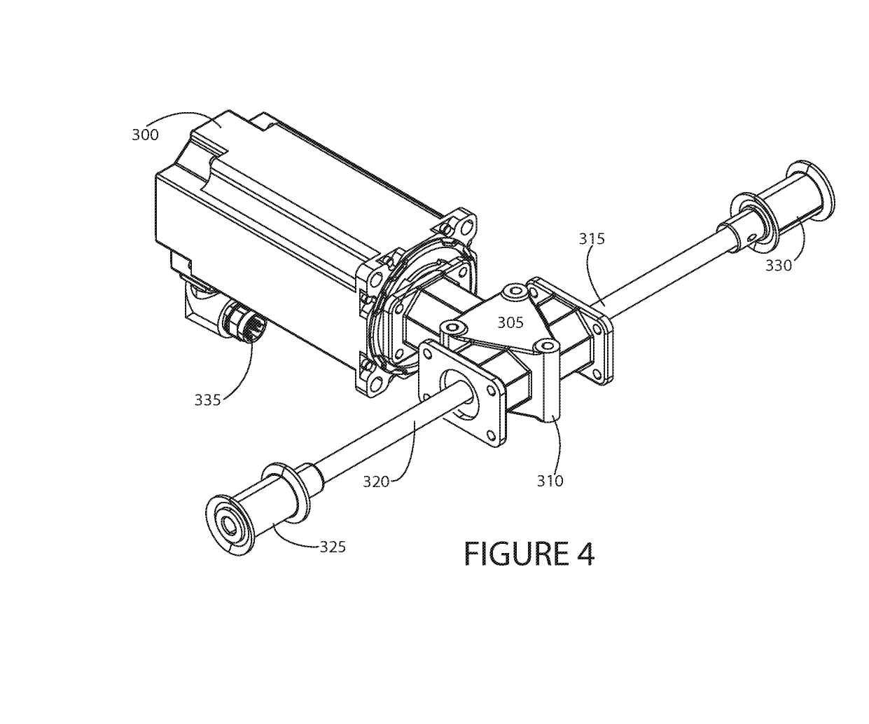

The hoist 100 contains a pair of rotating spools 325, 330 to wind and unwind tether 105, 110, for raising and lowering the light assembly 140. FIGS. 3 and 4 provide a plan view of an exemplary motor 300 and gear box 305 for a hoist 100 for a grow light 140 with height adjustment according to principles of the invention. The gear box 305 contains an input gear 326 coupled to an input shaft 312 driven by the motor 300. In the exemplary embodiment, two output shafts 320, 315 are driven by output gears 322, 324 that engage the input gear 326. A spool 325, 330 is provided on each shaft 315, 320 for winding and unwinding tethers 105, 110 of the hoist 100. Other gear and shaft configurations are possible. The invention is not limited to any particular type, configuration, or arrangement of gears or shafts.

In a preferred embodiment, the motor 300 is a servomotor, which allows for precise control of rotation. The servomotor includes a suitable motor coupled to a sensor for position feedback. A terminal 335 is provided for power supply and data. The servomotor 300 may use an optical encoder, either absolute or incremental, to accurately measure rotation and increments of rotation. The servomotor may be communicatively coupled to the PLC 155. The PLC 155 thus activates the servomotor 300 to raise or lower the light assembly 140 and receives data signals corresponding to rotations and position from the servomotor 300. In this manner, the PLC 155 may be used to determine the height of the light assembly 140.

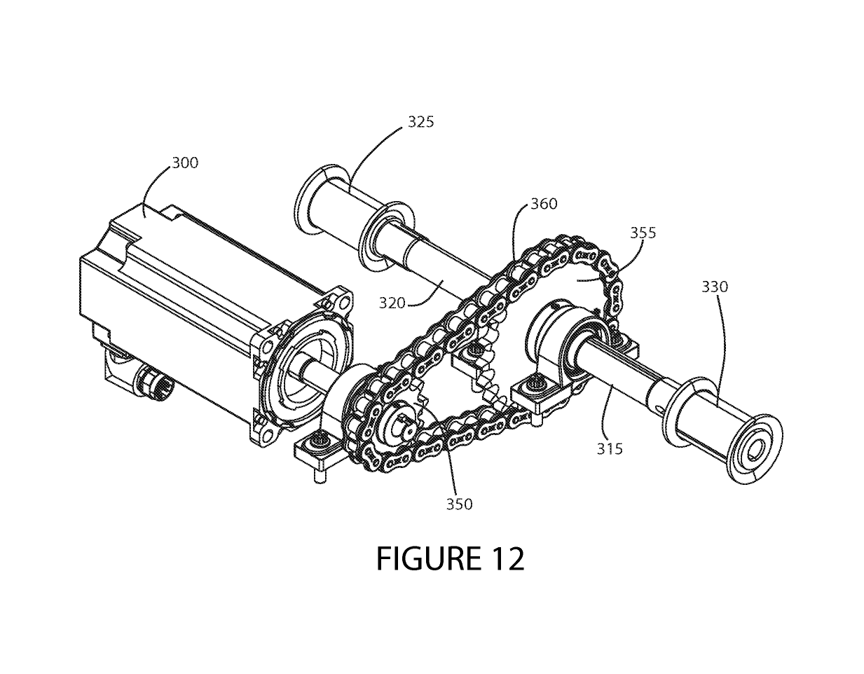

As one nonlimitating example of an alternative drive train for the hoist 100, a chain and sprocket may be used. With reference to the example of FIG. 12, the motor 300 drives a drive sprocket 350, which drives a chain 360, which drives a driven sprocket 355. A similar belt and pulley configuration is also feasible. Other configurations are possible. Any means for simultaneously rotating at least two spools at the same rotational rate, in the same or opposite directions of rotation, using a single motor, may be utilized within the scope of the invention.

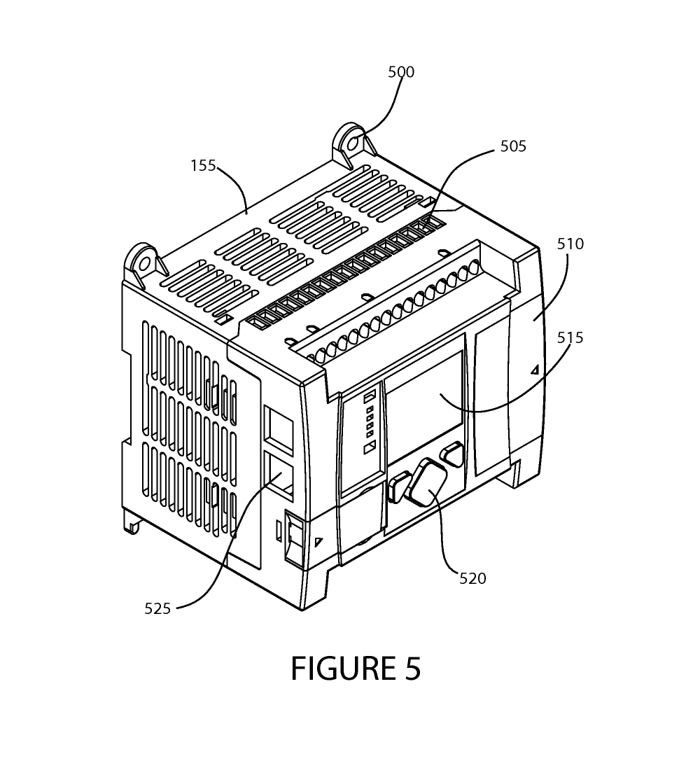

Referring now to FIG. 5, a perspective view of an exemplary programmable logic controller (PLC) 155 with computer network connectivity for a grow light with height adjustment according to principles of the invention is illustrated. The programmable logic controller (PLC) 155 automates electromechanical processes of the system, including reading sensor output, activating the light assembly to emit light, controlling which, if any, of the channel(s) of LED(s) is(are) illuminated, and monitoring and controlling the hoist to raise and lower the light assembly 140 in a controlled manner. The PLC 155 is configured for severe conditions (such as dust, moisture, heat, cold) and has a plurality of input/output (I/O) ports. One PLC 155 may serve one or more (e.g., a few) lighting systems depending upon configuration and modularity. The I/O ports 505 connect the PLC 155 to external devices such as sensors, relays, drivers and motors. The PLC 155 may include an access panel 510 to access internal components and ports, such as batteries and removable memory cards. In FIGS. 1 and 2, I/O ports are connected to the hoist 100 via lines 170, and to the optical sensor 180 via line 165. The PLC 155 executes a PLC program repeatedly as long as the controlled system is running. Input readings are copied to an I/O image table, which is an area of memory accessible to the processor. The PLC program runs from its first instruction rung down to the last rung. In the exemplary embodiment, the PLC 155 has one or more built in communications ports, e.g., RS-232, USB, Ethernet or some other communications port. In such embodiment, the PLC can communicate over a network to one or more computers running a SCADA (Supervisory Control And Data Acquisition) system or web browser. In the exemplary embodiment, the PLC includes an Ethernet interface 525 for an Ethernet connection via Category 5 or 6 cable 160 is illustrated. User input controls 520 and a visual display 515 may optionally be provided.

The PLC 155 may include a proportional-integral-derivative controller (PID controller) that calculates an “error” value as the difference between a measured process variable (e.g., light sensed, e.g., PPFD) and a desired setpoint (e.g., DLI). The process variable is determined from sensor input for the measured variable. The controller attempts to minimize the error by adjusting the process control variables (e.g., activation of light assembly 140 and lowering to an effective height) by outputting analog and/or digital logic level signals to controlled devices (e.g., the servo motor and lighting system power supply). Adjustment of the controlled devices via the analog and/or digital logic level signals influences the sensed process variables. In the interest of achieving a gradual convergence to desired setpoints (e.g., the target DLI), the controller may damp oscillations by tempering its adjustments, or reducing the loop gain, thereby avoiding or minimizing overshoot.

FIG. 6 provides a high level network schematic conceptually illustrating a plurality of programmable logic controllers for operably coupled to a plurality of grow lights with height adjustment and capable of being configured and monitored via computer according to principles of the invention. Each grow light system (e.g., L₁, 615 Lₓ 620, Lₙ, 625) includes a hoist 100 and light assembly 140 operably coupled to a PLC 155, 156. More than one grow light system (e.g., 615, 620) may be coupled to (i.e., share) the same PLC 155, if the PLC 155 provides sufficient I/O ports and processing capabilities. Each PLC 155, 156 may be communicatively coupled to a computer network 600 (e.g. a LAN). One or more computers 605, 610 may also be communicatively coupled to the network 600 and the PLCs, 155, 156. In such embodiment, the PLCs 155, 156 can communicate over the network 600 to the computers 605, 610 running a SCADA (Supervisory Control And Data Acquisition) system or web browser. A plurality of PLCs (e.g., dozens, hundreds or more) may be networked and monitored, controlled and reprogrammed from the supervising computers 605, 610.

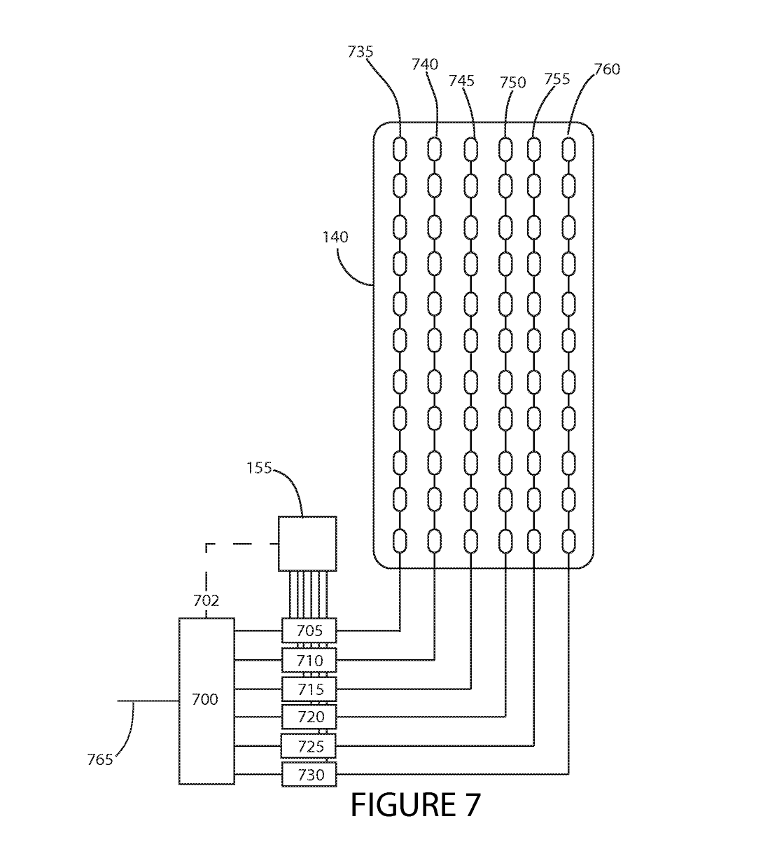

Referring now to FIG. 7, a high level schematic of a grow light assembly comprising a plurality of independent series of LEDs 735-760 and corresponding controllable drivers 705-730 of the light assembly 140 with a power supply 700 is shown. The drivers 705-730 are optional. The invention may be implemented with a power supply 700 without the drivers. The power supply 700 generates DC power at a current and voltage suitable for driving each series of LEDs 735-760. The power supply 700 may include a comparator for dimming via control of the forward current. A dimming control signal may be supplied from the PLC 155 via control signal line 702. Utility AC power may be supplied to the power supply via an input line 765.

In an implementation where each series of LEDs is independently controlled by a driver, one or more series 735-760 may be selectively illuminated using the controllable drivers 705-730. The controllable drivers 705-730 may comprise relays or integrated circuit LED drivers operably coupled to the PLC 155. A single multichannel LED driver may be utilized in lieu of multiple single channel drivers.

The series 735-760 may include red, amber, green, and blue LEDs. By way of example and not limitation, the assembly may include 40% Red, 20% Amber, 20% Green, and 20% Blue. Red LEDs may consist of at least 2 different Red LED frequencies to broaden the red frequency. spectrum. Additionally in a preferred embodiment, the light assembly provides about 60 watts of LEDs per linear foot of fixture or 6 square feet of light coverage. Each series 735-760 may comprise LEDs of only one of the aforementioned colors (i.e., wavelengths) or LEDs of more than one of the wavelengths. Fewer or more series may be included without departing from the invention. Series of LEDs may be dimmed either by pulse-width modulation or by lowering the forward current, either of which can be accomplished using the PLC 155 and/or compatibly configured LED drivers 705-730. Using such a system, the light intensity of one color (e.g., the blue spectrum) may be increased during germination/propagation, and the light intensity of another spectrum (e.g., the Red spectrum) may be increased during the plant grow out period.

Each LED series of a particular color may be controlled separately so that it can be adjusted independently based on the phase of the plant growth or other factors that are found to be required. This may be accomplished using the PLC 155 under control of one or more computers 605, 610. One exemplary goal may be to be emulate an artificial dawn/dusk that appears to the plants like a natural sunrise or sunset. The PLC 155 in cooperation with the computers 605, 610 may be programmed to activate lighting color that generates the greatest plant growth based on the phase of plant growth for the individual plant type. The control module (e.g., PLC 155 in cooperation with computers 605, 610) will sense light during daylight hours and provide LED supplemental lighting to meet specific light intensity requirements based on the amount of natural sunlight light intensity. The control module may adjust the lighting frequency, intensity and height based on the type and stage of plant of plant growth. The height above the plants may be adjusted based on the desired light intensity and the height required for adequate illumination of the covered plants, and potential damage (e.g., heat stress) that could take place due to being closer than the plants can endure.

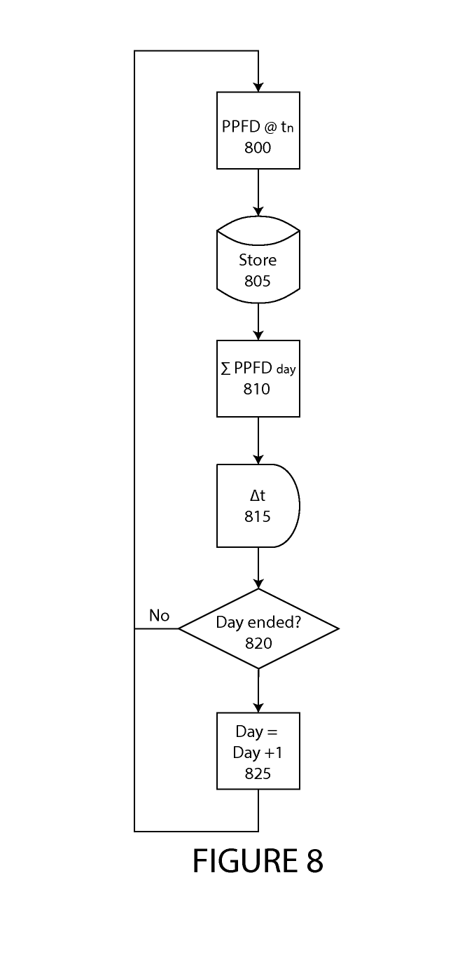

Referring now to FIG. 8, a high level flow chart illustrating steps of a process of determining cumulative photosynthetic photon flux density (PPFD) over a day in determined time increments according to principles of the invention. In step 800, a measurement of light intensity or quanta, such as PPFD, at a time interval tₙ is measured, sensed or estimated using an appropriate optical sensor, such as a quantum PAR sensor positioned at or near the plants being illuminated. The measured value may be stored in memory or on a storage medium, as in step 805. A cumulative total for the day, may be computed, as in step 810. The day may be defined as a calendar day or some other time period, for use in the processes. When the time passes to the next measurement interval, as in step 815, a determination is made if the day is over, as in step 820. If the day is not over, then control passes to step 800 and the process continues computing the PPFD at each time increment of the day. When the day is over, a new day is started, as in step 825, and the steps of the process resume for the new day. In this manner, lighting measurements for each time interval of each day are determined. Additionally, the total measured lighting (e.g., PPFD) for a day is determined. These determinations are used in the related processes described below.

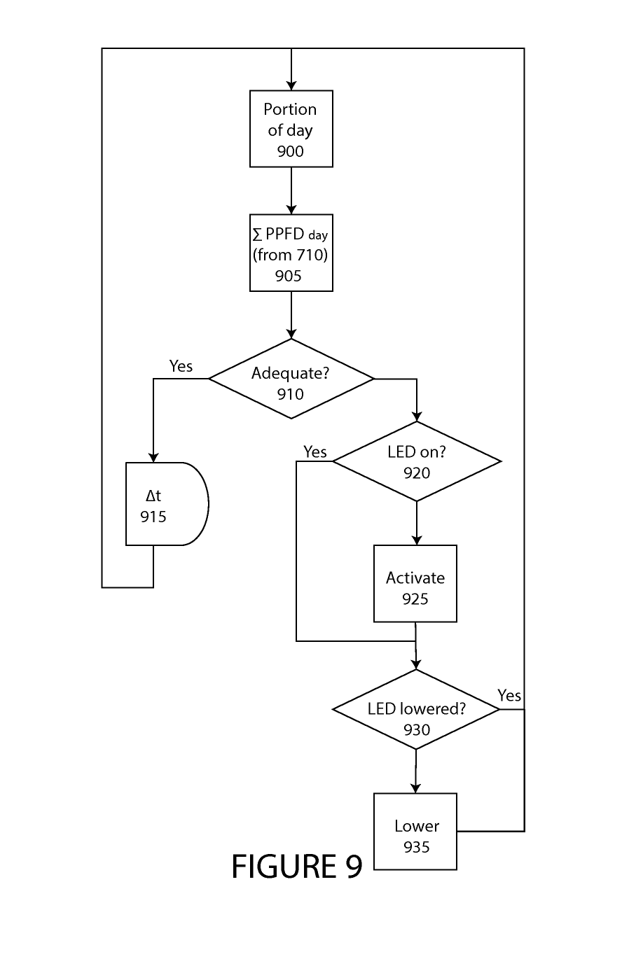

In FIG. 9, a high level flow chart illustrating steps of a process of activating and lowering a supplemental lighting fixture if the cumulative daily PPFD does not meet a target target value is shown. A portion of a day may be determined as in step 900. The total cumulative measured lighting for the day may be determined in step 905. Then a determination may be made if the lighting is adequate in relation to a target, as in step 910. For example, if the measured light accumulates to only one fourth of the target lighting, and the day is half way over, the lighting is inadequate. In contrast, if the accumulated measured light exceeds the lighting target for the portion of the day, then the lighting is adequate. If the lighting is inadequate, then determinations are made of whether or not the Light assembly is activated and whether the light assembly is lowered, as in steps 920 and 930. If the lighting assembly is not on, it may be activated to provided supplemental lighting, as in step 925. If the activated lighting assembly is not lowered, then the light assembly may be lowered to an appropriate height for the illuminated plants, as in step 935.

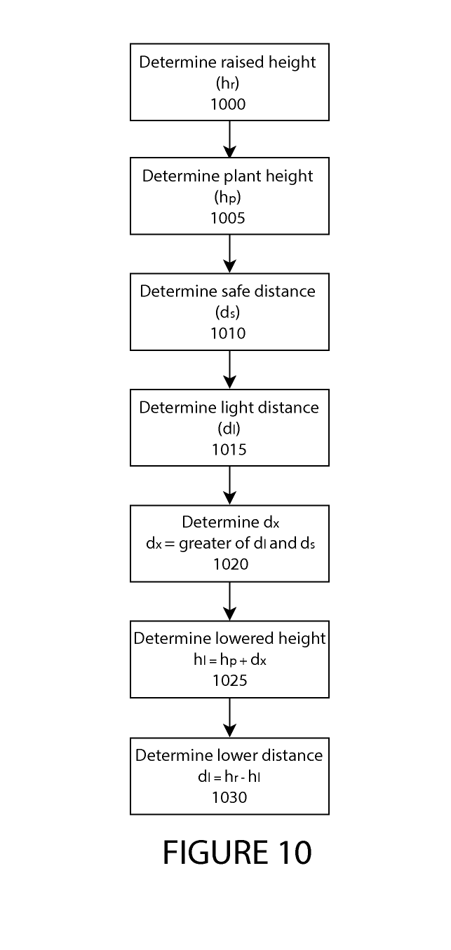

In general, the lowered height should be no higher than necessary to illuminate the covered plants and avoid heat stress. Any higher will substantially reduce the intensity of the light reaching the plants in accordance with the inverse square law. FIG. 10 provides a high level flow chart illustrating steps of a process of determining a distance for lowering a supplemental lighting fixture according to principles of the invention. The raised height (hᵣ) 1000 is the maximum height of the light assembly. The plant height (hₚ) 1005 is a function of the plant and growth stage, and may be measured and input and/or sensed, and/or estimated from an algorithm or stored data (e.g., a lookup table) for the plant. A safe distance (dₛ) 1010 from the plants is determined by the heating and cooling properties of the light assembly. In general two feet is considered safe for heat sinked LED light assemblies of 60 watts per linear foot. The light distance (dₗ) 1015 is the minimum distance for the light to reach the plants to be illuminated. Any lower and the light will not reach the plants at the periphery. This distance is a function of the divergence of the collimated light from the assembly as determined from the lamps (e.g., LEDs) and lenses. A determination is made whether the safe distance or light distance is greater, as in step 1020. The greater of the two is dₓ, the distance from the plants for positioning the light assembly. The lowered height (hₗ) is the plant height (hₚ) plus dₓ, as determined in step 1025. The distance to lower the light assembly from the raised height is then the raised height (hᵣ) minus the lowered height (hₗ).

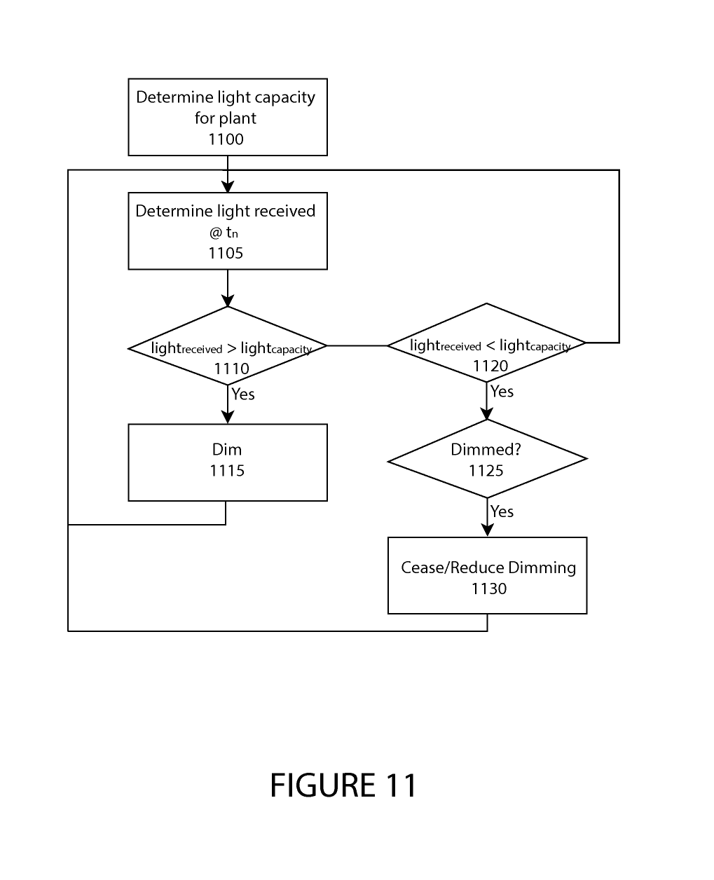

As plants can utilize only a limited amount of light at any moment, it is inefficient to supply excessive supplemental light to a plant. The excessive light represents wasted electricity and unnecessary heating. Additionally, excessive light may trigger photoinhibition, which can impair growth and survivability. In the flowchart of FIG. 11, the light capacity of a plant (e.g., light saturation point—the light intensity is determined in step 1100, such as from user input or a look up table or other source for the plant being illuminated. The light capacity may be input as mols per square meter per second. The light received (e.g., PPFD) at a particular time (tₙ) is determined in step 1105, such as from sensor 180. If the light received exceeds the light capacity, as determined in step 1110, then dimming is implemented in step 1115. Dimming may be accomplished either by pulse-width modulation or lowering the forward current. If the light capacity exceeds the light received, as determined in step 1120, and the supplemental lighting has already been dimmed as determined in step 1125, then dimming is either reduced or ceased in step 1130. A reduction of dimming may be accomplished either by increasing the pulse-width modulation frequency or increasing the forward current. Steps 1105-1130 repeat for each time interval, to determine if dimming is warranted or if dimming should be reduced or ceased. In this manner, the plant is supplied as much supplemental light as the plant can safely utilize. Excess supplemental light is not wasted.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A method of automatically illuminating a plurality of plants with an overhead supplemental lighting assembly to facilitate plant growth, said method comprising steps of:
determining, at about a height of and adjacent to the plurality of plants, an intensity of light received, and
determining a target light intensity for the plurality of plants, and
comparing the determined intensity of light received with the target light intensity; and
if the determined intensity of light received is less than the target light intensity, then automatically lowering the supplemental lighting assembly from a raised position to a lowered position, and activating the supplemental lighting assembly to emit supplemental lighting to the plurality of plants from the supplemental lighting assembly at the lowered position.

2. The method of automatically illuminating a plurality of plants according to claim 1, said plurality of plants having foliage, and the step of determining, at about the height of and adjacent to the plurality of plants, the intensity of light received comprising positioning an optical sensor at about a height of the foliage of and adjacent to the plurality of plants.

3. The method of automatically illuminating a plurality of plants according to claim 2, said optical sensor comprising a photodiode.

4. The method of automatically illuminating a plurality of plants according to claim 2, said optical sensor sensing photosynthetically active radiation.

5. The method of automatically illuminating a plurality of plants according to claim 2, said optical sensor comprising a quantum PAR sensor sensing photosynthetically active radiation as photosynthetic photon flux density.

6. The method of automatically illuminating a plurality of plants according to claim 5, said plurality of plants comprising a certain species of plants and the target light intensity comprising a target photosynthetic photon flux density for the certain species of plants.

7. The method of automatically illuminating a plurality of plants according to claim 6, said target photosynthetic photon flux density for the certain species of plants comprising a photosynthetic photon flux density value determined by a computer from a lookup table.

8. The method of automatically illuminating a plurality of plants according to claim 6, said target photosynthetic photon flux density for the certain species of plants comprising a photosynthetic photon flux density value inputted via a computer.

9. The method of automatically illuminating a plurality of plants according to claim 1, the step of automatically lowering the supplemental lighting assembly comprising activating a motor operably coupled to a spool with a tether partially wound on the spool, the supplemental lighting assembly being coupled to a free end of the tether, and the activated motor causing the spool to rotate and tether to unwind from the spool thereby lowering the supplemental lighting assembly.

10. The method of automatically illuminating a plurality of plants according to claim 1, the lowered position being at a height above the plurality of plants that avoids causing heat stress to any of the plurality of plants.

11. The method of automatically illuminating a plurality of plants according to claim 8, the lowered position being at a height above the plurality of plants that illuminates all of the plurality of plants.

12. The method of automatically illuminating a plurality of plants according to claim 9, the height above the plurality of plants being about a minimum height above the plurality of plants to avoid causing heat stress to the plurality of plants and illuminate all of the plurality of plants, while minimizing losses due to distance between the supplemental lighting assembly and the plurality of plants.

13. The method of automatically illuminating a plurality of plants according to claim 1, further comprising determining a light saturation point for the plurality of plants, and determining if the sensed intensity of the light received exceeds the saturation point, and determining if the supplemental lighting assembly is in the lowered position and activated, and, if the sensed intensity of the light received exceeds the saturation point, and if the supplemental lighting assembly is in the lowered position and activated, then dimming the supplemental lighting from the supplemental lighting assembly.

14. The method of automatically illuminating a plurality of plants according to claim 13, the step of dimming the supplemental lighting from the supplemental lighting assembly comprising dimming the supplemental lighting by a determined percentage using one of pulse width modulation or regulating forward current to the supplemental lighting assembly.

15. The method of automatically illuminating a plurality of plants according to claim 15, the supplemental lighting assembly comprising 40% red, 20% amber, 20% green, and 20% blue light emitting diodes.

16. A method of automatically illuminating a plurality of plants with an overhead supplemental lighting assembly to facilitate plant growth, said method comprising steps of:
determining an intensity of light received by the plurality of plants, and
determining a target light intensity for the plurality of plants, and
comparing the determined intensity of light received with the target light intensity; and
if the determined intensity of light received is less than the target light intensity, then lowering the supplemental lighting assembly from a raised position to a lowered position, and activating the supplemental lighting assembly to emit supplemental lighting to the plurality of plants from the supplemental lighting assembly at the lowered position, said lowered position being closer to the plurality of plants than the raised position.

17. (canceled)

18. (canceled)

19. (canceled)

20. (canceled)
